(19) United States
(12) Patent Application Publication
(10) Pub. No.: US 2019/0126415 A1
(43) Pub. Date: May 2, 2019

(54) Device for mounting a blank on a modular supporting system

(71) Applicant: REM Industrie S.r.l., Padova (IT)

(72) Inventor: Sebastiano Piccolo, Camposampiero (IT)

(21) Appl. No.: 16/093,683

(22) PCT Filed: Apr. 12, 2017
(86) PCT No.: PCT/EP2017/058769

§ 371 Date: Oct. 15, 2018

(30) Foreign Application Priority Data
Apr. 14, 2016 (IT) 102016000038358

(51) Int. Cl. B23Q 3/04; B23Q 3/10; F16M 11/06; F16M 11/22

(52) U.S. Cl. CPC B23Q 3/04; B23Q 3/103; F16M 2200/024; F16M 11/22; F16M 11/06

(57) ABSTRACT

A device for mounting a blank on a modular supporting system includes a first component fixing the supporting system to a supporting base plate and having a first main reference axis; a second component fixing the supporting system to a blank and having has a second main reference axis; and a rotary joint having a rotation axis that is transverse to both of the first and second main reference axes, and further having a first part that is fixed to the first component and that has a contoured pivoting portion to allow the rotation thereon of a second part, fixed to the second component, about the rotation axis, the rotary joint including a reversible element causing a stable locking between the first part and the second part in an angular position selected between a plurality of available angular positions.

The present invention relates to a device for mounting a blank on a modular supporting system.

Modular supporting systems are currently known for the reversible locking of a blank in preparation for machining operations, such as chip-forming machining, which comprise a plurality of different components designed to be combined so as to provide a stable, safe and precise support in order to keep a blank in a precise preset position available for the machine tools.

Modular supporting systems are currently known and increasingly widespread, owing to their practicality and functionality, which comprise a supporting base plate provided with an array of seats for the fixing of spacer components which are contoured to support the blank in a preset position.

In particular, various modular fixing devices are commercially available which adapt to the geometry of the existing workpiece even with angular joints, such as for example a mounting device with a spherical joint, which comprises a threaded body to be screwed to a corresponding hole provided on the blank, said threaded body being coupled to a supporting spacer, which is adapted to be coupled to a supporting plate, indeed by means of a spherical joint.

Although this spherical joint mounting device adapts well to any angular position, it has the severe drawback of not defining a stable position; during machining, due to the stresses that the mounting device experiences through the machined workpiece, the preset angular position can in fact be lost, with consequent machining errors.

The aim of the present invention is to provide a device for mounting a blank on a modular supporting system that is capable of maintaining a preset inclination unchanged during an entire machining process.

Within this aim, an object of the present invention is to provide a mounting device that can be adapted and used with modular supports of the known type.

Another object of the present invention is to provide a mounting device that is simple to use.

This aim and these and other objects which will become better apparent hereinafter are achieved by a device for mounting a blank on a modular supporting system according to claim 1.

Further characteristics and advantages of the invention will become better apparent from the description of a preferred but not exclusive embodiment of the mounting device according to the invention, illustrated by way of nonlimiting example in the accompanying drawings, wherein:

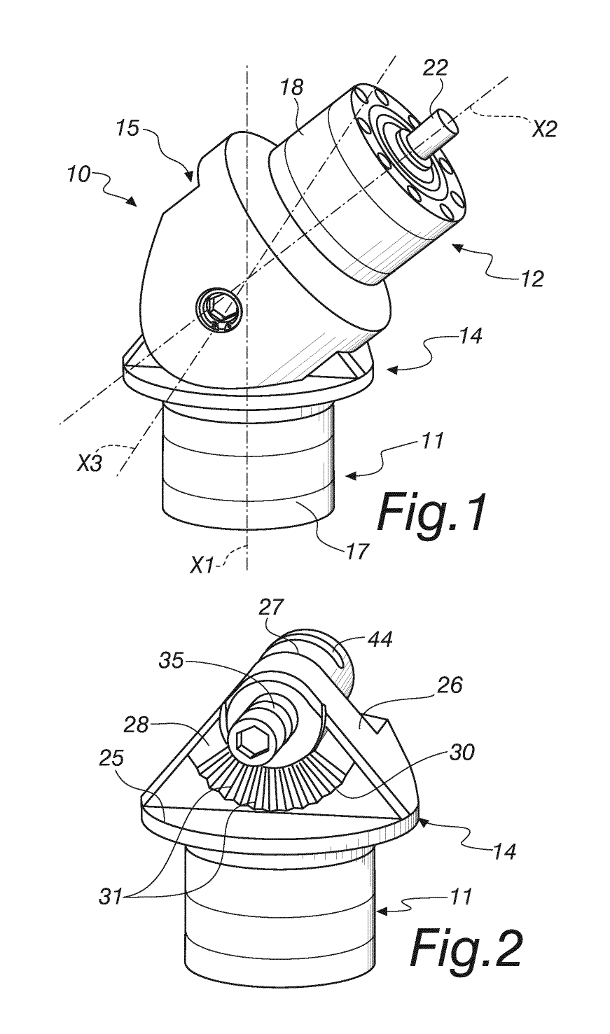

FIG. 1 is a perspective view of a device according to the invention;

FIG. 2 is a view of a first part of a device according to the invention;

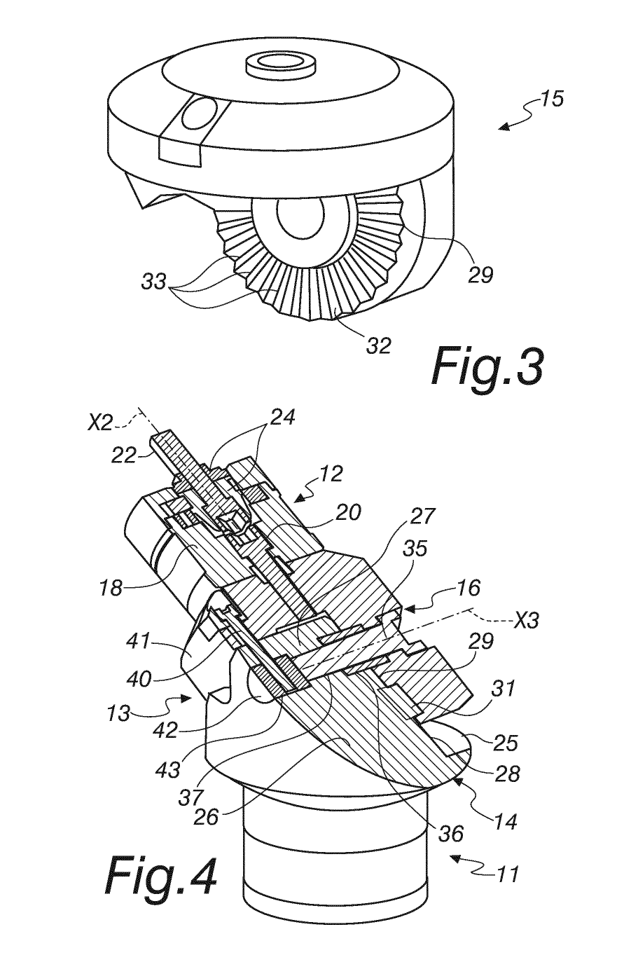

FIG. 3 is a view of a second part of a device according to the invention;

FIG. 4 is a first sectional view of the device according to the invention;

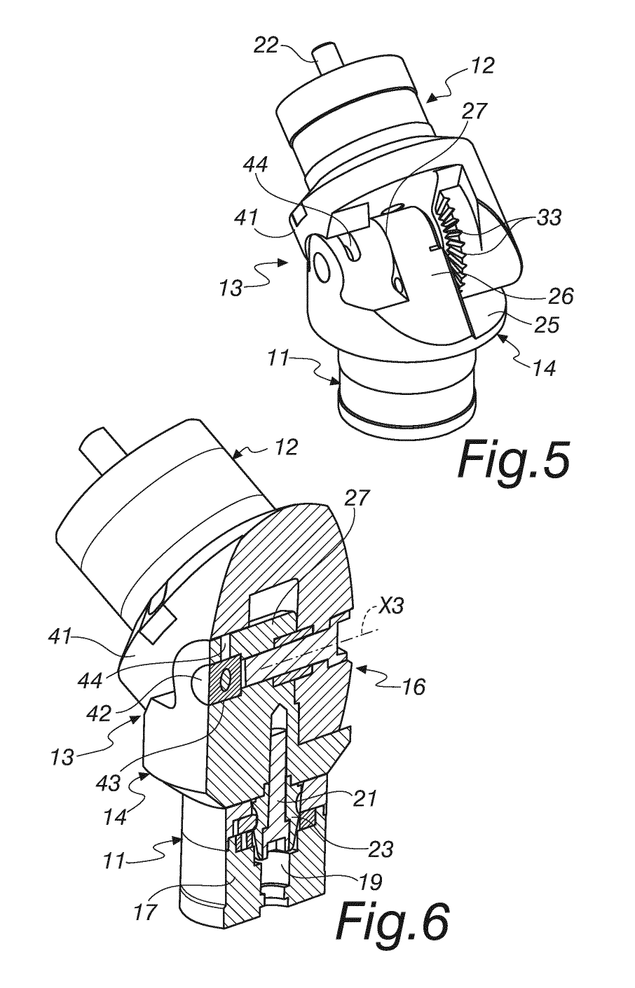

FIG. 5 is another perspective view of the device according to the invention;

FIG. 6 is a second sectional view of a device according to the invention;

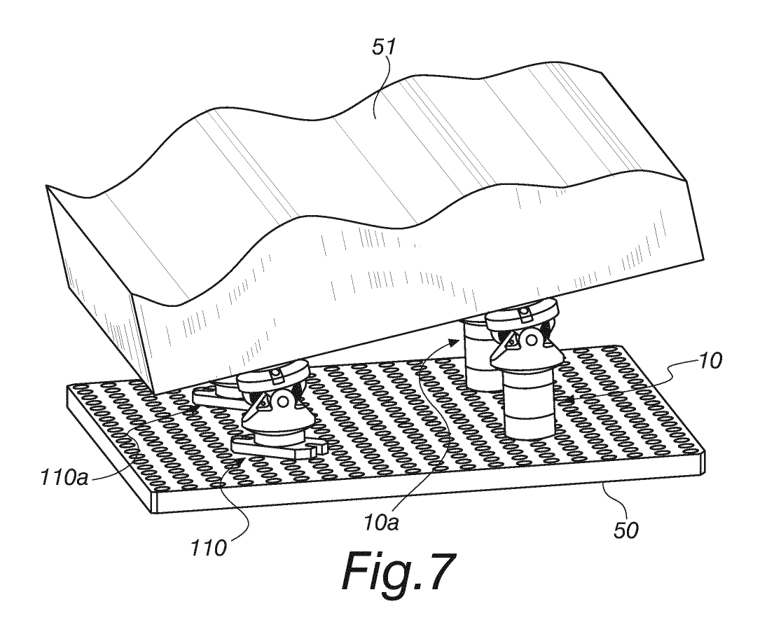

FIG. 7 is a view of an example of application of a series of mounting devices according to the invention.

With reference to the figures, a device for mounting a blank on a modular supporting system is designated generally by the reference numeral 10.

The device 10 comprises:
a first component 11, for fixing to a supporting base plate, which is not shown and is to be understood as being of a known type, which has a first main reference axis X1,
a second component 12, for fixing to a blank, which has a second main reference axis X2,
a rotary joint 13, with a rotation axis X3 that is transverse with respect to both of the main axes X1 and X2 of the first component 11 and the second component 12.

The rotary joint 13 comprises a first part 14, which is fixed to the first component 11 and has a pivoting portion 26 that is contoured to allow the rotation thereon of a second part 15, which is fixed to the second component 12, about the rotation axis X3 of the rotary joint 13.

The rotary joint 13 comprises reversible means 16 for stable locking between the first part 14 and the second part 15 in an angular position selected from a plurality of available angular positions.

The first component 11 and the second component 12 are for example of a per se known type and both comprise a respective cylindrical body 17 and 18 with a through hole 19 and 20 that is contoured to accommodate a fixing screw 21 and 22 respectively, and corresponding elements for centering and angular adaptation 23 and 24 for the screw.

The fixing screw 21 of the first component 11 is designed for fixing to the first part 14 of the rotary joint 13, while the fixing screw 22 of the second component 12 is designed for the fixing of the second component 12, and therefore of the entire device 10, to a blank.

The rotary joint 13 has a rotation axis X3 that is perpendicular to the plane on which the other two axes axes X1 and X2 lie.

The first part 14 is constituted by a disk-like portion 25, from which the pivoting portion 26 extends which is contoured to allow the rotation thereon of the second part 15.

The pivoting portion 26 comprises a cylindrical segment 27, which is coaxial to the rotation axis X3, and a first interface surface 28, which is provided with rotation-preventing protrusions and is adapted to engage a corresponding second interface surface 29 formed on the second part 15 of the rotary joint 13, provided with corresponding rotation-preventing protrusions which are adapted to arrange themselves, in a chosen angular position, between the rotation-preventing protrusions of the first interface surface 28.

The first interface surface 28 has an arrangement which is perpendicular to the rotation axis X3.

The rotation-preventing protrusions of the first interface surface 28 are constituted by a toothed arc 30 with front teeth 31.

Likewise, the rotation-preventing protrusions of the second interface surface 29 are constituted by a toothed arc 32, with front teeth 33, which is shaped complementarily with respect to the toothed arc 30 of the first interface surface 28 of the first part 14.

The reversible means 16 for stable locking between the first part 14 and the second part 15 are constituted by an axial screw 35, which is adapted to pass through a through hole 36 which is formed, again axially, in the second part 15, in order to screw into a threaded hole 37 which is formed on the first part 14, as shown in FIG. 4.

By screwing the axial screw 35, the toothed arcs 30 and 32 of the first part 14 and second part 15 are coupled, stabilizing a preset angular position chosen among the plurality of possible angular positions allowed by the number of teeth 31 and 33 of the two facing toothed arcs 30 and 32.

By loosening the screw that keeps the toothed arcs 30 and 32 clamped, it is possible to disengage the sets of teeth and rotate the two parts 14 and 15, for example with an angular spacing of 20°.

The set of teeth, once coupled, by virtue of its particular self-centering design, is also capable of withstanding forces that might arrive radially from the machining processes performed on the workpiece that is fixed to the device 10.

The cylindrical segment 27 cooperates to better withstand the machining forces.

In particular, in order to clamp everything and reduce the plays required for movement between the first part 14 and the second part 15 of the rotary joint 13, the device 10 comprises a radial screw 40, which is inserted in the body 41 of the second part 15 in a radial direction with respect to the rotation axis X3 and is screwed to an axial cylindrical insert 42 which is accommodated in an adapted seat 43 of the first part 14.

Obviously, in order to allow the rotation of the radial screw 40 together with the second part 15, a slot-like opening 44 is provided on the cylindrical segment 27 of the first part 14.

The use of the mounting device 10 according to the invention therefore entails that first of all a mounting angle is established between the axes X1 and X2 of the first component 11 and the second component 12, and then the axial screw 35 is unscrewed in order to release from mutual engagement the two toothed arcs 30 and 32, the first part 14 and the second part 15 are rotated with respect to each other about the rotation axis X3 so as to define said mounting angle, and then the axial screw 35 is screwed in again so as to render the angular position stable.

The radial screw 40 also is screwed in so as to eliminate as much as possible the plays between the two parts 14 and 15 of the rotary joint 13.

The preloading forces produced by the screwing of the radial screw 40 into the axial insert 42, which are generated by the clamping of the radial screw 40, preload the second part 15 on the first part 14, adding a surface for transmission of the machining forces, which adds to the coupling of the toothed arcs 30 and 32.

FIG. 7 shows an example of application of a series of mounting devices according to the invention, for example two devices 10 and 10a as described above, and two second devices 110 and 110a which comprise different first and second components, which have a lower height but also are to be understood as being of a known type.

A supporting base plate is designated by the numeral 50, while a generic supported blank is designated by the reference numeral 51.

In practice it has been found that the invention achieves the intended aim and objects.

In particular, the invention provides a device for mounting a blank on a modular supporting system that is capable of maintaining a preset inclination unchanged during an entire machining process.

Furthermore, the invention provides a mounting device that can be adapted and used with modular supports of a known type.

Moreover, the invention provides a mounting device that is simple to use.

The invention thus conceived is susceptible of numerous modifications and variations, all of which are within the scope of the appended claims; all the details may further be replaced with other technically equivalent elements.

In practice, the components and materials used, so long as they are compatible with the specific use, as well as the contingent shapes and dimensions, may be any according to the requirements and the state of the art.

The disclosures in Italian Patent Application No. 102016000038358 (UA2016A002585) from which this application claims priority are incorporated herein by reference.

Where technical features mentioned in any claim are followed by reference signs, those reference signs have been included for the sole purpose of increasing the intelligibility of the claims and accordingly such reference signs do not have any limiting effect on the interpretation of each element identified by way of example by such reference signs.

1. A device (10) for mounting a blank on a modular supporting system, comprising:
a first component (11), fixing to the supporting system to a supporting base plate, and having a first main reference axis (X1);
a second component (12), fixing the supporting system to a blank, and having a second main reference axis (X2); and
a rotary joint (13) having a rotation axis (X3) that is transverse to both of said first and said second main reference axes (X1, X2),
said rotary joint (13) comprising a first part (14) that is fixed to said first component (11) and has a pivoting portion (26), which is contoured to allow a rotation thereon of a second part (15), which is fixed to said second component (12), about said rotation axis (X3),
said rotary joint (13) comprising a reversible element (16) that stably locks said first part (14) and said second part (15) in an angular position selected between a plurality of available angular positions.

2. The mounting device according to claim 1, wherein said rotary joint (13) has said rotation axis (X3) perpendicular to a plane on which the first and the second main reference axes (X1, X2) lie.

3. The mounting device according to claim 1, wherein said first part (14) is constituted by a disk-shaped portion (25), from which said pivoting portion (26) extends, said pivoting portion being contoured to allow the rotation thereon of the second part (15).

4. The mounting device according to claim 1, wherein said pivoting portion (26) comprises a cylindrical segment (27), which is coaxial to the rotation axis (X3), and a first interface surface (28), which is provided with rotation-preventing protrusions and is adapted to engage a corresponding second interface surface (29) formed on the second part (15) of the rotary joint (13), which is provided with corresponding rotation-preventing protrusions adapted to arrange themselves, in the selected angular position, between the rotation-preventing protrusions of the first interface surface (28).

5. The mounting device according to claim 1, wherein said first interface surface (28) is arranged to be perpendicular to the rotation axis (X3).

6. The mounting device according to claim 4, wherein said rotation-preventing protrusions of the first interface surface (28) are constituted by a first toothed arc (30), with first front teeth (31), the rotation-preventing protrusions of the second interface surface (29) being constituted by a second toothed arc (32), with second front teeth (33), the second toothed arc being shaped complementarily with respect to the first toothed arc (30).

7. The mounting device according to claim 1, wherein said reversible element (16) is constituted by an axial screw (35) that is adapted to pass through a through hole (36) that is formed, axially, in the second part (15), in order to screw into a threaded hole (37) that is formed in the first part (14).

8. The mounting device according to claim 1, further comprising a radial screw (40), which is inserted in a body (41) of the second part (15) in a radial direction with respect to the rotation axis (X3), and is screwed to an axial cylindrical insert (42) that is accommodated in a seat (43) in the first part (14).

9. The mounting device according to claim 4, wherein a slot-shaped opening (44) is provided in said cylindrical segment (27) of the first part (14).
